(19) United States
(12) Patent Application Publication
(10) Pub. No.: US 2007/0000871 A1
(43) Pub. Date: Jan. 4, 2007

(54) Floor-etching solution

(75) Inventor: Edward E. Durrant, Providence, UT (US)

Correspondence Address: Starkweather & Associates, Suite 200, 9035 South 1300 East, Sandy, UT, 84094, US

(73) Assignee: HARRIS RESEARCH, INC.

(21) Appl. No.: 11/174,049

(22) Filed: Jul. 1, 2005

(51) Int. Cl. C09K 13/00; B44C 1/22

(52) U.S. Cl. 216/83; 252/79.1

(57) ABSTRACT

The present invention is directed toward a floor-etching solution comprising a ketone such as 1-methyl-2-pyrrolidinone, a surfactant, and water. The solution further comprises a viscosity such that it may be applied to a surface by spraying, spritzing, or other similar application methods. The solution further comprises an evaporation rate low enough that it does not completely evaporate from the surface for at least 15 minutes.

### BACKGROUND OF THE INVENTION

1. Field of the Invention

The present invention relates to floor-etching solutions, specifically floor-etching solutions including a ketone, surfactant, and devoid of thickening agents and the method of use of the floor-etching solutions.

2. Description of the Related Art

Floors and other surfaces often include a finish. The applied finish may be applied for various reasons including to protect the substrate and to give a desired appearance. For various reasons, there may be a need to strip or etch the finish. One reason for stripping or etching the finish is so that a new or another coat of finish may be applied. When a new finish is applied to an existing finish without first stripping or etching the finish, the new finish may delaminate from the existing finish. Delamination may result in poorly-protected substrate and less than desirable appearance.

The known stripping solutions used for removing coatings from wood substrates typically contain large percentages of methylene chloride and/or highly flammable solvents, or are caustic or acid solutions. Products currently used by professionals do not lend themselves to relatively safe use by the general public. Although substantially the same disadvantages are encountered by both professionals and the general public, these disadvantages are more acute with respect to the general public. Such disadvantages include toxicity, flammability, volatility, non- or inadequate biodegradeability and difficulty in application and/or removal of the solution.

A paint stripper that does not contain methylene chloride is disclosed in U.S. Pat. No. 4,666,626 which generally discloses a paint stripper composition containing oxo-hexyl acetate as the chief cleaning agent in combination with cyclohexanone. The compositions preferably also contain furfuryl alcohol, an aromatic naptha solvent, methyl cellulose thickener, dodecyl benzene sulfonate, N-methyl-2-pyrrolidinone (NMP), diisobutyl ketone and sodium xylene sulfonate. It is also stated the composition readily emulsifies with water and is removable by water. The solution of this disclosure requires a thickener, and is thus not suitable for spraying.

Thickeners are at times added to stripping solutions to increase the viscosity such that the stripping solution remains on a surface for sufficient time to soften, blister, or delaminate the existing finish. Thickening agents may be especially beneficial when the surface to be stripped is fixed in a vertical position, such as a wall, or the lower surface of a horizontal plane, such as a ceiling. Thickening agents, however, may increase the difficulty of applying the solution to a surface.

Although NMP is known for use primarily as an activator or cosolvent in certain paint, varnish and other coating removers, it is also known for use as an active solvent in some coating remover formulations.

U.S. Pat. No. 5,545,136 discloses a clear composition remover for wood substrates with water as a major constituent. The composition includes NMP, dibasic ester, a propylene glycol or glycol ether, a thickener (hydroxypropyl cellulose), and water. Because thickener is included in the solution of this disclosure, the solution is not easily sprayed.

U.S. Pat. No. 5,011,621 discloses a composition for removing coatings. The composition includes NMP and plant or animal-derived oil, and may include co-solvents, surfactant, detergent, and thickener. The solution of this disclosure requires several relatively expensive chemicals, as well as thickener. As above, the thickener increases the difficulty of spraying the solution.

It is believed, but not meant to be limiting, that a solvent, when applied to an existing finish, creates sites on the existing finish that promote bonding between the existing finish and a newly-applied finish. Thus if a new finish is applied to an existing finish that has been treated with the solvent, that the new finish will not delaminate to the same extent that it would delaminate if surface had not been treated with the solvent. The creation of the sites on the existing finish as a result of the application of the solvent may be described as “softening” of the existing finish. Thus, an existing finish with sites resulting from the application of the solvent may be described as “soft”.

What is needed is a floor-etching solution that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available floor-etching solution. Accordingly, the present invention has been developed to provide a floor-etching solution including a ketone, water, and a surfactant, and a sufficiently low rate of evaporation such that the solution may not substantially completely evaporate from a surface in less than about 15 minutes. The solution may be devoid of a thickening agent.

The ketone in the solution may be in the general form of 2-pyrrolidinone such as 2-pyrrolidinone, 1-methyl-2-pyrrolidinone (NMP), and 1-ethyl-2-pyrrolidinone.

The solution can be from about 15 to about 50 weight percent ketone, and from about 20 to about 80 weight percent water.

Additional constituents such as of color additives, solvents, activators, rust inhibitors, miscibilizing solvents, fireproofing agent, stabilizer, surfactant, evaporation inhibitors, and mixtures thereof may be added to the solution.

The solution may have a viscosity of less than about 50 cP at 25° C., and greater than about 0.08 cP at 25° C.

The invention also provides for a method of etching a surface. The method may include the steps of applying the solution to a finished surface and etching the finished surface. Finish may then be added to the etched surface.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

It has been discovered that stripping or etching the finish on a finished surface before applying a new finish to the surface results in less delamination of the new finish. The floor-etching solution herein may be beneficial in stripping and/or etching the finish in preparation for application of a new finish. It is believed, but not meant to be limiting to this invention, that etching or stripping the finish on a finished surface creates sites that promote chemical bonding between the existing finish and the newly-applied finish.

The floor-etching solution of the present invention may be used to strip or etch paints, lacquers, polyurethanes, acrylics, protectants and other finishes and coatings from various substrates. Finishes that are commonly applied to wood floors include polyurethanes and acrylic finishes. The floor-etching solution may be used without significant damage, such as etching, pitting or corrosion to such substrate.

The floor-etching solution includes a polar aprotic solvent, water, and a surfactant.

The polar aprotic solvent may be a ketone. The solvent may be cyclic or have cyclic constituents. The solvent may contain a heteroatom such as, but not limited to nitrogen, oxygen, silicon, sulfur, and phosphorus. The cyclic portion of the structure of the solvent may contain a heteroatom such as, but not limited to nitrogen, oxygen, silicon, sulfur, and phosphorous. Some non-limiting examples of a polar aprotic solvent include 2-pyrrolidinone compounds, formamide, dimethylformamide (DMF), N-methylformamide, dimethylsulfoxide (DMSO), and dimethylacetamide (DMAC).

In a preferred embodiment, the solvent includes a 2-pyrrolidinone. The 2-pyrrolidinone compounds of the present invention may include those represented by the following formula: 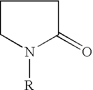
where R may be hydrogen, or a mono-valent organic group. Some non-limiting examples of mono-valent organic groups include alkyl of 1 to 4 carbon atoms or u hydroxyalkyl of 1 to 4 carbon atoms. Some non-limiting examples of such 2-pyrrolidnone compounds include 2-pyrrolidinone, 1-methyl-2-pyrrolidinone (NMP), and 1-ethyl-2-pyrrolidinone. In a further preferred embodiment, the solvent includes NMP.

The surfactant may be any surfactant known to one skilled in the art. One of skill in the art is familiar with ionic, anionic and zwitterionic surfactants. In one embodiment, the surfactant is chosen as one that would work to reduce the surface tension of the floor-etching solution. One skilled in the art would recognize a wide variety of surfactants that would serve to reduce the surface tension of the floor-etching solution. One skilled in the art would also recognize the relative amount of surfactant necessary for the floor-etching solution. For example, one skilled in the art could easily calculate the relative amount of surfactant needed to reduce the surface tension of the floor-etching solution while keeping the viscosity of the solution within reasonable parameters as described herein. In one embodiment, the surfactant is an anionic surfactant.

It is believed, but not meant to be limiting, that the surfactant may serve to lower the surface tension of the floor-etching solution. Further it is believed that the reduced surface tension may allow for the solution to spread on the surface instead of remaining substantially in droplet shape. In an embodiment where the solution is applied to the surface by spraying or spritzing or similar methods, the solution may be formed into droplets by the spraying. It is further believed that the added surfactant reduces the surface tension of the droplets such that the droplets may spread across a greater area of the surface than if they remained in droplet form. As a result, the added surfactant may result in reducing the need for mechanical spreading of the floor-etching solution.

In one embodiment, the floor-etching solution includes at least about 15 weight percent of a ketone, and preferably at least about 25 weight percent of a ketone; and less than about 50 weight percent of a ketone. In one embodiment, the floor-etching solution includes at least about 40 weight percent water, or at least about 50 weight percent water; and less than about 89 weight percent water, or less than about 80 weight percent water. In one embodiment, the floor-etching solution includes at least about 0.05 weight percent surfactant, or at least about 0.1 weight percent surfactant; and less than about 5 weight percent surfactant, or less than about 2 weight percent surfactant. In one embodiment, the floor-etching solution contains about 0.25 weight percent surfactant.

It has been observed that as the solvent evaporates from the surface, delamination of a newly-applied finish may be more likely. Thus it is believed, but not meant to be limiting, that as the solvent evaporates from the surface, fewer sites exist on the surface (the surface becomes less soft), allowing for fewer bonds to be formed between the existing finish and the newly-applied finish. Thus it is an object of this invention to provide a floor-etching solution that allows the solvent to remain on the surface for sufficient time. The sufficient time would be known in the art, and can include sufficient time, for example, for the floor to be etched or stripped and a new finish applied before the solvent completely evaporates. As known in the art, during the process of refinishing, a finish may remain on an existing finish for a relatively long time before a new finish is applied to the surface. In one embodiment, the floor-etching solution has an evaporation rate low enough such that the floor-etching solution does not substantially completely evaporate from a surface for at least 15 minutes. In another embodiment, the floor-etching solution does not substantially completely evaporate from a surface for at least 30 minutes. In another embodiment, the floor-etching solution does not substantially completely evaporate from a surface for at least one hour.

One skilled in the art would recognize that additional constituents may be added to the floor-etching solution without detracting from the invention. Non-limiting examples of constituents include color additives, additional solvents such as, for example, water, diluents, ethers, activators, rust inhibitors, miscibilizing solvents, fireproofing agents, stabilizers, surfactants, evaporation inhibitors, and so forth. The amounts of these optional ingredients may be calculated by one of skill in the art to achieve the desired effects of the optional ingredients. For example, it is known in the art that rust inhibitors and accelerators may be added in the amount of from about 0.1 to about 10 weight percent to achieve the desired effects of the rust inhibitors and accelerators.

In one embodiment, the floor-etching solution is devoid of constituents greatly increasing the toxicity of the solution. One example of one such constituent is methylene chloride. In one embodiment, the floor-etching solution is devoid of methylene chloride.

In a preferred embodiment. the floor-etching solution may be devoid of thickening agents. Thickening agents may serve to increase the viscosity of the floor-etching solution. In one embodiment the floor-etching solution is applied to a surface by spraying techniques. Any spraying technique known in the art may be used in this embodiment. However, it is believed that the more viscous the solution, the more difficult it is to apply the solution by spraying techniques. The viscosity in this embodiment should be sufficiently low to allow for application of the solution by spraying techniques. In one embodiment, the viscosity of the solution is less than about 50 cP at 25° C., or less than about 25 cP at 25° C.; and greater than about 0.08 cP at 25° C. In another embodiment, the viscosity of the solution is about 1 cP at 25° C.

The constituents of the floor-etching solution may be combined by any method known in the art. The constituents may be combined and mechanically mixed.

The floor-etching solution may be used to etch or strip many of the commonly used finishes, paints, and lacquers. Some examples of coatings and finishes that may be etched or stripped using the floor-etching solution include acrylic latex type enamel, alkyd and acrylic enamels, polyesters, epoxy resin coatings, polyvinyls, polyvinyl cinnamates, polyamides, polyimides, shellacs polyurethane coatings, oil-based alkyl resin, varnish/lacquer, glycerophthalic paints, alkyd-urethane paints, acrylic-polyurethane paints, epoxy paints, latex paints, phenolic coatings, gum varnishes, silicone coatings, polyalkyl acrylates, polyalkyl methacrylates, polyvinyl acrylates, and so forth.

The substrate on which the existing finish is applied may include any substrate known in the art. Such substrates may include, for example, wood, metals (such as aluminum, galvanized steel, stainless steel and automotive steel), glass, acrylic-type plastics, concrete, sheetrock, plasterboard, and so forth.

The method of etching includes the steps of applying the floor-etching solution to the surface, and optionally etching the surface. The method of application may be any known in the art such as, for example, spraying, spritzing, squirting, brushing, pouring, dumping, rolling, immersion, and so forth. The preferred methods of application include spraying, spritzing, squirting, and similar methods.

The amount of solution applied to the surface may be sufficient to substantially completely cover a portion of the surface to be stripped or etched. The amount of solution applied to the surface may be an amount to sufficiently soften the existing finish. One of skill in the art could calculate these amounts. One of skill in the art would recognize the various factors for consideration of the amount of solution needed to sufficiently cover and/or sufficiently soften the surface intended to be etched or stripped. Such factors may include, for example, the composition of the existing finish, the surface area needed to be stripped or etched, the length of time needed between application of the solution and optional addition of a new finish, the age of the existing finish, the amount of damage to the existing finish, and so forth.

Optionally, after applying the solution to the existing finish, time may be allowed to pass for the existing surface to soften, swell, blister, or become detached. Additional solution may be applied as needed to substantially cover and/or to soften the area intended to be stripped or etched.

At least a portion of the existing finish may then be etched or stripped by any technique known in the art. It is believed, but not meant to be limiting, that etching the existing finish increases the softness of the existing finish. Techniques for etching or stripping the existing surface may include, for example, scraping, scouring, rinsing, and so forth. A tool may be used to facilitate etching of the surface. Non-limiting examples of a tool that may be used include a surface-working apparatus with a scrubbing or etching pad, a floor sander, or other device that works to etch the existing finish.

In one embodiment, substantially all of the surface covering is removed. A part of the substrate may be removed with the floor-etching solution and the existing finish. In one embodiment, substantially none of the substrate is removed along with the floor-etching solution and existing finish.

In one embodiment, the existing finish is less than completely removed. The existing finish may be etched such that the existing surface becomes soft, but the existing finish is not completely removed from the substrate.

Optionally, after the existing finish has been stripped or etched, additional finish may be applied to the existing finish and/or substrate.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the description illustrates only mechanical mixing as a method of producing the solution, it is envisioned and within the scope of this invention that any technique known in the art for producing the solution may be used. For example, the constituents of the solution may be added in any order known in the art.

A solution of a portion of the water and a portion of the surfactant may be added to the solvent, and the remaining water may be later added to the solution. The various constituents may be added to the solution at any time before use of the solution. For example, water that was not added to the solution may be added by the user of the solution immediately before application of the solution to the surface. In this example, the concentration of the solution could be varied by an end user in accordance with the users needs by adding more or less water to the solution. As another example, it is within the scope of this invention that the constituents may be combined immediately before application of the solution to the surface. Further, the constituents may be combined after application to the surface.

Any technique of mixing the constituents is within the scope of this invention. Some example of mixing include stirring, agitating, shaking, flow mixing and so forth.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

In order to demonstrate the practice of the present invention, the following examples have been prepared. The examples should not, however, be viewed as limiting the scope of the invention. The claims will serve to define the invention.

### EXAMPLES

Five solutions were made. Each solution contained about 0.25 weight percent of an anionic surfactant. Solutions 1-5 contained specified amounts of NMP, and the balance of each solution was water, in accordance with the following chart:

| Solution | Anionic Surfactant | NMP | Water |
|---|---|---|---|
| 1 | 0.25 | 0 | 99.75 |
| 2 | 0.25 | 5.00 | 94.75 |
| 3 | 0.25 | 10.00 | 89.75 |
| 4 | 0.25 | 25.00 | 74.75 |
| 5 | 0.25 | 50.00 | 49.75 |

where all amounts are given in weight percent.

Each solution was sprayed onto individual sections of pre-finished wood floor. The solution was allowed to dwell for about 5 minutes. The sections were then buffed with an abrasive maroon pad sold under the 3M® brand. After buffing each area for the same amount of time, the areas were wiped clean of any residue and observed.

The areas that had been treated with solutions 1, 2 and 3 showed very little evidence of being etched. The areas that had been treated with solutions 4 and 5 were well etched.

What is claimed is:

1. A floor-etching solution comprising:
from about 15 to about 50 weight percent of a ketone;
water;
surfactant;
devoid of a thickener; and
a rate of evaporation sufficiently low such that the solution does not substantially completely evaporate from a surface in less than about 15 minutes.

2. The floor-etching solution of claim 1 wherein the ketone is represented by the formula: 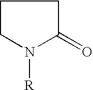
where R comprises a hydrogen atom or a mono-valent organic group.

3. The floor-etching solution of claim 2 wherein the ketone selected from the group consisting of 2-pyrrolidinone, 1-methyl-2-pyrrolidinone, and 1-ethyl-2-pyrrolidinone.

4. The floor-etching solution of claim 3 wherein the ketone comprises 1-methyl-2-pyrrolidinone.

5. The floor-etching solution of claim 1 wherein the ketone comprises from about 25 to about 50 weight percent of the solution.

6. The floor-etching solution of claim 1 wherein the water comprises from about 20 to about 80 weight percent of the solution.

7. The floor-etching solution of claim 1 further comprising one selected from the group consisting of color additives, solvents, activators, rust inhibitors, miscibilizing solvents, fireproofing agent, stabilizer, surfactant, evaporation inhibitors, and mixtures thereof.

8. A floor-etching solution comprising:
a sufficiently low rate of evaporation such that the solution does not substantially completely evaporate from a surface in less than about 15 minutes;
a viscosity of less than about 50 cP at 25° C.;
a ketone;
water; and
a surfactant.

9. The floor-etching solution of claim 8 wherein the rate of evaporation is sufficiently low such that the solution does not substantially completely evaporate from a surface in less than about 30 minutes.

10. The floor-etching solution of claim 8 wherein the viscosity comprises less than about 25 cP at 25° C.

11. The floor-etching solution of claim 10 wherein the viscosity comprises about 1.0 cP at 25° C.

12. The floor-etching solution of claim 8 wherein the ketone comprises from about 15 to about 50 weight percent of the solution.

13. The floor-etching solution of claim 8 wherein the ketone is represented by the formula: 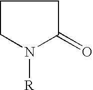
where R comprises a hydrogen atom or a mono-valent organic group.

14. The floor-etching solution of claim 13 wherein the ketone is selected from the group consisting of 2-pyrrolidinone, 1-methyl-2-pyrrolidinone, and 1-ethyl-2-pyrrolidinone.

15. The floor-etching solution of claim 14 wherein the ketone comprises 1-methyl-2-pyrrolidinone.

16. A method of etching a surface comprising:
applying to a finished surface a floor-etching solution which comprises:
a ketone represented by the formula: 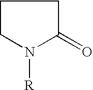
where R comprises a hydrogen or a mono-valent organic group;
a sufficiently low rate of evaporation such that the solution does not substantially completely evaporate from a surface in less than about 15 minutes;
a viscosity of less than about 50 cP at 25° C.;
water; and
a surfactant; and
etching at least a portion of the finished surface.

17. The method of claim 16 wherein the ketone comprises 1-methyl-2-pyrrolidinone.

18. The method of claim 17 wherein the viscosity comprises less than about 25 cP at 25° C.

19. The method of claim 18 further comprising the step of applying a finish to the etched surface.

20. The method of claim 16 wherein the floor-etching solution comprises devoid of a thickening agent.
